(19) United States
(12) Patent Application Publication
(10) Pub. No.: US 2002/0126202 A1
(43) Pub. Date: Sep. 12, 2002

(54) Apparatus

(75) Inventors: Karl J. Wood, Crawley (GB); Richard J. Allen, Redhill (GB); Cees Van Berkel, Hove (GB)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/077,062

(22) Filed: Feb. 15, 2002

(30) Foreign Application Priority Data
Mar. 9, 2001 (GB) 0105801.5

(51) Int. Cl. H04N 13/00

(52) U.S. Cl. 348/59; 348/42; 348/51

(57) ABSTRACT

Apparatus for producing a stereoscopic image comprises a display and a user control for controlling a stereoscopic parameter of the image. The control may be a single control for example a knob and may control more than one parameter. Alternatively there may be two controls each controlling a single parameter. The apparatus may further comprise a lenticular screen overlying the display for producing a stereoscopic image that is autostereoscopic.

This invention relates to apparatus for producing a stereoscopic image.

A stereoscopic image is one that when viewed by a user appears as a three dimensional image. The user may need to wear special glasses to produce the three dimensional effect or if the display is autostereoscopic then such glasses are not required.

Examples of autostereoscopic display apparatus are described in the paper entitled “3-D Displays for Video Telephone Applications” by D. Sheat et al in Eurodisplay 1993 and in GB-A-2196166. In these apparatuses, the display is produced by a matrix display device comprising a matrix LC (liquid crystal) display panel having a row and column array of display elements and acting as a spatial light modulator. Overlying the display is an image deflection device in the form of a lenticular sheet, whose lenticules, comprising (semi) cylindrical lens elements, extend in the column direction of the display panel with each lenticule overlying a respective group of two, or more, adjacent columns of display elements and extending parallel with the display element columns. Commonly in such apparatus, the LC matrix display panel is of a conventional form, comprising regularly spaced rows and columns of display elements, as used in other types of display applications, e.g. computer display screens, although other arrangements may be provided.

Considering a direct-view type of apparatus, then the display pixels forming the display are constituted by the display elements of the display panel. In an arrangement in which each lenticule is associated with two columns of display elements, the display elements in each column provide a vertical slice of a respective 2D (sub-)image. The lenticular sheet directs these two slices and corresponding slices from the display element columns associated with the other lenticules, to the left and right eyes respectively of a viewer in front of the sheet so that the viewer perceives a single stereoscopic image. In other, multi-view, arrangements, in which each lenticule is associated with a group of four, or more, adjacent display elements in the row direction, and in which corresponding columns of display elements in each group are arranged appropriately to provide a vertical slice from a respective 2-D (sub-) image then as a viewer moves his or her head a series of successive, different, stereoscopic views are perceived creating, for example, a look-around impression.

The simplest stereoscopic display produces two different images, one each for the right and left eye of the user. When these two images are created and then combined on the display of the apparatus a number of assumptions about the user are used. For example the distance between the user's eyes and the distance of the user from the display are based on known averages and these values are used in the process of producing the image that is displayed. For some users this produces a stereoscopic image that is uncomfortable to view, or cannot easily be focussed on or cannot be seen at all.

It is therefore an object of the invention to provide an improved apparatus for producing a stereoscopic image.

According to a first aspect of the present invention, there is provided apparatus for producing a stereoscopic image comprising display means for displaying an image and user control means for controlling at least one stereoscopic parameter of the image displayed by the display means.

According to a second aspect of the invention, there is provided a method for producing a stereoscopic image comprising displaying an image and controlling at least one stereoscopic parameter of the image in response to a user input.

Owing to the invention, it is possible to provide apparatus for producing a stereoscopic image that can be user adjusted to suit the stereoscopic viewing preference of that user.

Embodiments will now be described, by way of example, with reference to the accompanying drawings, in which:—

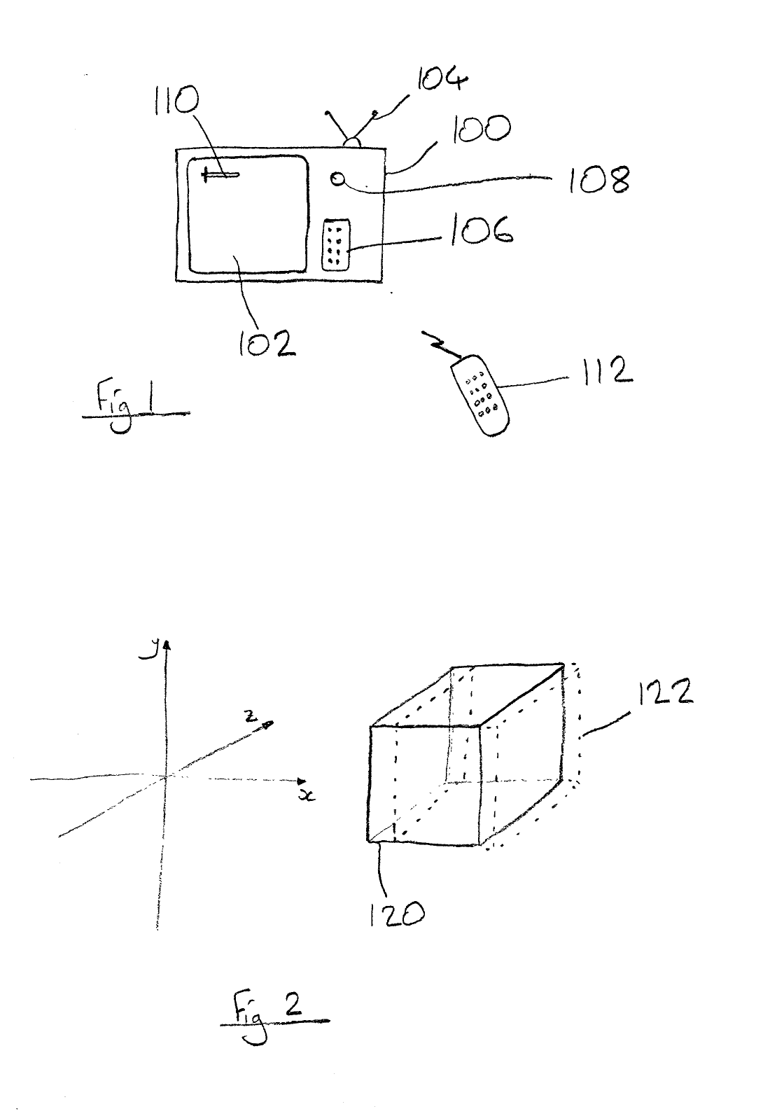

FIG. 1 is a front view of stereoscopic apparatus with a remote control,

FIG. 2 is a schematic diagram showing two images to be displayed to create a stereoscopic image,

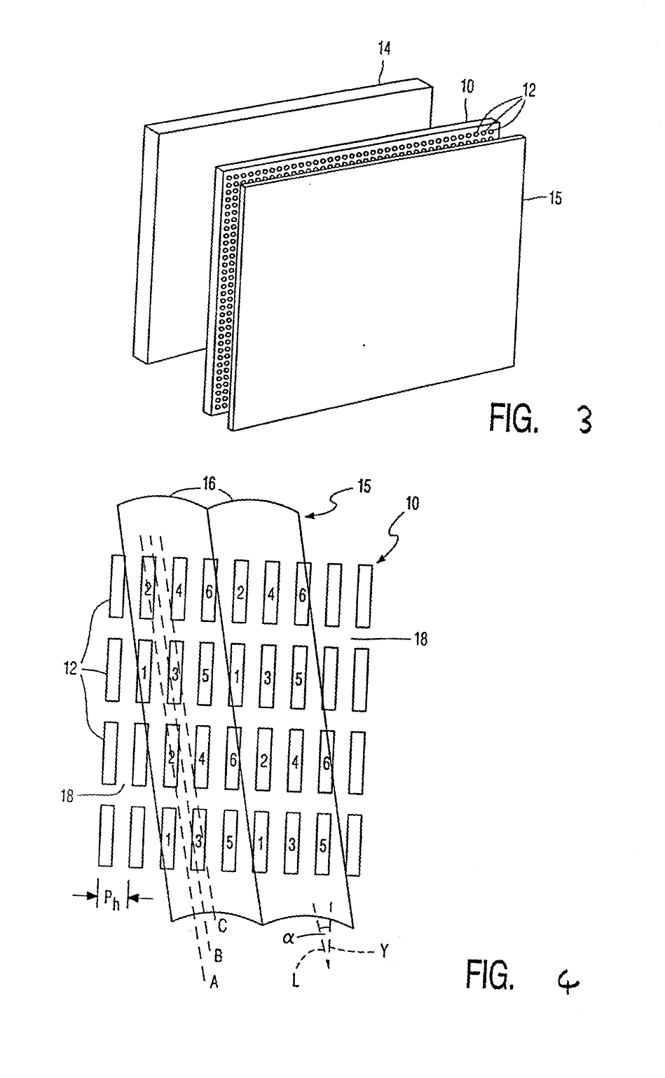

FIG. 3 is a schematic perspective view of an autostereoscopic display apparatus, and

FIG. 4 is a schematic plan view of a part of the display element array of the display panel of FIG. 3, providing a six view output.

FIG. 1 shows the apparatus 100 for producing a stereoscopic image including display means in the form of a liquid crystal display 102 for displaying an image, an aerial 104 and standard controls 106. A knob (rotary control) 108 and an icon 110 are provided and either or both of these operate as user control means for controlling one or more stereoscopic parameters of the image shown by the display 102.

When a user is viewing the stereoscopic image, if there is any problem, such as the user feeling uncomfortable with the image displayed, or the user is having difficulty seeing the three dimensional effect, when they can adjust the stereoscopic parameters with the knob 108. The user control means need not be in a hardware form, it could be implemented in software and therefore take the form of an icon 110 which a user can adjust via, for example, a keyboard (not shown). A remote control 112 could be used by the viewer as a remote device for communicating with the user control means.

FIG. 2 shows how two images are used to create a stereoscopic (three-dimensional) image. If a cube is to be displayed then two different images 120, 122 (illustrated in dotted lines for clarity only) are shown on the display 102 separated by a defined distance along the x-axis. In stereoscopic apparatus the user wears special glasses that result in a first image 120 reaching the left eye only and a second image 122 reaching the right eye only. These images are then combined by the brain to give the three dimensional effect. In autostereoscopic apparatus (described in more detail below) image deflection means overlying the display separate the two images and the user does not need to wear special glasses.

There are two principal stereoscopic parameters that effect the resulting image. The first parameter is the perceived depth of the image, which is controlled by the amount of x-axis separation of the two images 120, 122. The greater the x-axis separation of the images 120, 122 the more depth there is in the resulting stereoscopic image. The second parameter is the perceived position of the image relative to the display 102, which is controlled by the amount of x-axis separation per z-axis depth of the two images 120, 122. In FIG. 2, the x-axis separation of the two images 120, 122 is constant for all z-axis depths. In the resulting stereoscopic image half of the object is perceived to be in front of the display 102 and half behind. If the x-axis separation is not constant i.e. the image 122 is separated from image 120 by an amount that varies in proportion to the z-axis depth then the resulting stereoscopic image will be perceived to be more in front or more behind the display 120. A greater x-axis separation at the front of the images 120, 122 stretches the resulting stereoscopic image forward and a greater x-axis separation at the back of the images 120,122 stretches the resulting stereoscopic image backward.

The single control knob 108 is arranged to control the x-axis separation of the images 120 and 122 such that when the knob 108 is at a minimum the perceived depth of the image is at a minimum and as the knob 108 is moved towards a maximum the perceived depth of the image increases.

The knob 108 could alternatively control the second stereoscopic parameter i.e. the perceived position of the image relative to the display 102. The knob 108 could control both parameters in combination, or a second knob (not shown) could control the second stereoscopic parameter. The knob could be any simple mechanical control such as a slide or the like.

As the user adjusts the knob 108 the two views used to create the 3D effect are re-rendered from different view points, to achieve the desired visual change.

An example of a direct-view (autostereoscopic) type of display apparatus will be described with reference to FIGS. 3 and 4. A more detailed description of this apparatus is given in EP-A-0791847 the disclosure of which is herein incorporated by reference.

It will be understood that FIGS. 3 and 4 are merely schematic and are not drawn to scale. For clarity of illustration, certain dimensions may have been exaggerated whilst other dimensions may have been reduced.

Referring to FIG. 3, the display apparatus includes a conventional liquid crystal matrix display panel 10 used as a spatial light modulator and comprising a planar array of individually addressable and similarly sized display elements 12 arranged in aligned rows and columns perpendicularly to one another. Whilst only a few display elements are shown, there may in practice be around 800 columns (or 2400 columns if colour, with RGB triplets used to provide a full colour display) and 600 rows of display elements. Such panels are well known and will not be described here in detail.

The display elements 12 are substantially rectangular in shape and are regularly spaced from one another with the display elements in two adjacent columns being separated by a gap extending in column (vertical) direction and with the display elements in two adjacent rows being separated by a gap extending in the row (horizontal) direction. The panel 10 is of the active matrix type in which each display element is associated with a switching element, comprising for, example, a TFT or a thin film diode, TFD, situated adjacent the display element.

The display panel 10 is illuminated by a light source 14 which, in this example, comprises a planar back-light extending over the area of the display element array. Light from the source 14 is directed through the panel with the individual display elements being driven, by appropriate application of drive voltages, to modulate this light in conventional manner to produce a display output. The array of display-pixels constituting the display produced thus corresponds with the display element array, each display element providing a respective display pixel.

Over the output side of the panel 10, opposite that facing the light source, there is disposed image deflection means in the form of a lenticular sheet 15 comprising an array of elongate, parallel lenticules 16, or lens elements, acting as optical director means to provide separate images to a viewer's eyes, producing a stereoscopic display to a viewer facing the side of the sheet 15 remote from the panel 10. The lenticules of the sheet 15, which is of conventional form, comprise optically cylindrically converging lenticules 16, for example formed as convex cylindrical lenses or graded refractive index cylindrical lenses. Autostereoscopic display apparatus using such lenticular sheets in conjunction with matrix display panels are well known in the art although, unlike the conventional arrangement in such apparatuses, with lenticules extending parallel to the display pixel columns (corresponding to the display element columns), the lenticules in the apparatus of FIG. 3 are arranged slanted with respect to the columns of display pixels, that is, their main longitudinal axis is at an angle to the column direction of the display element array. This arrangement has been found to provide a number of benefits in terms of reduced resolution loss and enhanced masking of the black area between display elements, as is described in the above-referenced application number EP-A-0791 847.

The pitch of the lenticules 16 is chosen in relation to the pitch of the display elements in the horizontal direction according to the number of views required, as will be described, and each lenticule, apart from those at the sides of the display element array, extends from top to bottom of the display element array. FIG. 4 illustrates an example arrangement of the lenticules in combination with the display panel for a typical part of the display panel. The longitudinal axis of the lenticules, L, is slanted at an angle α to the column direction,C. In this example, the spacing between the longitudinal axes of the parallel lenticules is of such a width with respect to the pitch of the display elements in a row, and slanted at such an angle with respect to the columns of display elements, as to provide a six view system. The display elements 12 are numbered (1 to 6) according to the view -number to which they belong. The individual, and substantially identical, lenticules of the lenticular sheet 15, here referenced at 16, each have a width which corresponds approximately to three adjacent display elements in a row, i.e. the width of three display elements and three intervening gaps. Display elements of the six views are thus situated in groups comprising display elements from two adjacent rows, with three elements in each row.

The individually operable display elements are driven by the application of display information in such a manner that a narrow slice of a 2D image is displayed by selected display elements under a lenticule. The display produced by the panel comprises six interleaved 2D sub-images constituted by the outputs from respective display elements. Each lenticule 16 provides six output beams from the underlying display elements with view-numbers 1 to 6 respectively whose optical axes are in mutually different directions and angularly spread around the longitudinal axis of the lenticule. With the appropriate 2D image information applied to the display elements and with a viewer's eyes being at the appropriate distance to receive different ones of the output beams then a 3D image is perceived. As the viewer's head moves in the horizontal (row) direction then a number of stereoscopic images can be viewed in succession. Thus, a viewer's two eyes would see respectively, for example, an image composed of all display elements “1” and an image composed of all display elements “2”. As the viewer's head moves, images comprised of all display elements “3” and all display elements “4” will be seen by respective eyes, then images comprised of all display elements “3” and all display elements “5”, and so on. At another viewing distance, closer to the panel, the viewer may, for example, see views “1” and “2” together with one eye and views “3” and “4” together with the other eye.

The plane of the display elements 12 coincides with the focal plane of the lenticules 16, the lenticules being suitably designed and spaced for this purpose, and consequently position within the display element plane corresponds to viewing angle. Hence all points on the dashed line A in FIG. 4 are seen simultaneously by a viewer under one specific horizontal (row direction) viewing angle as are all points on the dashed line B in FIG. 4 from a different viewing angle. Line A represents a (monocular) viewing position in which only display elements from view “2” can be seen. Line B represents a (monocular) viewing position in which display elements from both view “2” and view “3” can be seen together. Line C in turn represents a position in which only display elements from view “3” can be seen. Thus, as the viewer's head moves, with one eye closed, from the position corresponding to line A to line B and then line C a gradual change-over from view “2” to view “3” is experienced.

The slanting lenticule arrangement can be applied to both monochrome and colour displays. Considering, for example, the six-view scheme of FIG. 2 applied to an LC display panel in which a colour microfilter array is associated with the display element array and arranged with the colour filters running in R-G-B column triplets (i.e. with three successive columns of display elements displaying red, green and blue respectively), then if the view “1” display elements in the second row are red, then the view “1” display elements of the fourth row will be green. A similar situation occurs for the other views. Hence each view will have coloured rows which means that for a colour display the vertical resolution is divided by three compared with a monochrome display.

As in the embodiment of FIG. 1, when a user views the autostereoscopic display of FIGS. 3 and 4 if there is any discomfort then he can adjust one or more stereoscopic parameters in the same fashion as described above in relation to the first embodiment.

The user control means can be used with any stereoscopic type of display for example plasma displays, shutter glasses displays and the imax type of display which uses two projectors with opposing polarisations and the user wears polaroid glasses.

1. Apparatus for producing a stereoscopic image comprising display means for displaying an image and user control means for controlling at least one stereoscopic parameter of the image displayed by the display means.

2. Apparatus according to claim 1, said apparatus further comprising image deflection means overlying said display means.

3. Apparatus according to claim 2, wherein said image deflection means is a lenticular screen.

4. Apparatus according to claim 1, wherein said user control means is a single control.

5. Apparatus according to claim 4, wherein said single control is a knob.

6. Apparatus according to claim 4, wherein said single control is an icon.

7. Apparatus according to claim 1, said apparatus further comprising a remote device communicating with said user control means.

8. Apparatus according to claim 1, wherein said user control means controls two stereoscopic parameters.

9. Apparatus according to claim 1, wherein a stereoscopic parameter is the perceived depth of the image.

10. Apparatus according to claim 1, wherein a stereoscopic parameter is the perceived position of the image relative to the display means.

11. Apparatus according to claim 9 as appended to claim 4, wherein said apparatus is arranged so that when said single control is at a minimum the perceived depth of the image is at a minimum and as said single control moves from a minimum to a maximum the perceived depth of the image increases.

12. Apparatus according to claim 1, wherein said display means is a liquid crystal display.

13. A method for producing a stereoscopic image comprising displaying an image and controlling at least one stereoscopic parameter of the image in response to a user input.

14. A method according to claim 13, wherein said image is autostereoscopic.

15. A method according to claim 13, wherein said user input is via a single control.

16. A method according to claim 13, wherein a stereoscopic parameter is the perceived depth of the image.

17. A method according to claim 13, wherein a stereoscopic parameter is the perceived position of the image relative to its display.

18. A computer program product, for carrying out any one of the method claims 13 to 17.
